(19) United States
(12) Patent Application Publication
(10) Pub. No.: US 2010/0194209 A1
(43) Pub. Date: Aug. 5, 2010

(54) APPLIANCE SAFETY SYSTEM FOR PROTECTED OPERATION OF DANGEROUS MOTOR APPLIANCES, ESPECIALLY GARDENING APPLIANCES AND TOOLS

(75) Inventor: Wolfgang Richter, Germering (DE)

Correspondence Address: KATTEN MUCHIN ROSENMAN LLP, 575 MADISON AVENUE, NEW YORK, NY, 10022-2585, US

(73) Assignee: IDENT TECHNOLOGY AG, Wessling (DE)

(21) Appl. No.: 11/721,365

(22) PCT Filed: Dec. 9, 2005
(86) PCT No.: PCT/EP05/13255

§ 371 Date: Jun. 15, 2009

(30) Foreign Application Priority Data
Dec. 9, 2004 (DE) 10 2004 059 582.8

(51) Int. Cl. H02H 11/00

(52) U.S. Cl. 307/326

(57) ABSTRACT

The invention relates to a system for protected operation of dangerous motor appliances, especially gardening appliances, such as hedge or edge clippers, power saws and lawnmowers. The object of the invention is to provide solutions by which advantages in terms of operating safety are achieved during operation of motor appliances, especially hand-held gardening and forestry appliances as well as power tools. In an initially abstract description, this object is achieved according to the invention by an appliance safety system for averting dangerous operating situations in the use of motor-powered appliances. This system comprises field-preparing means for generating a capacitive spatial alternating field and detecting means for detecting a condition that can be classified as dangerous and/or shutdown by detecting relevant electric-field effects during penetration of an object into the zone being sensed by each field.

The invention relates to a system for protected operation of dangerous motor appliances, especially gardening appliances, such as hedge or edge clippers, power saws and lawnmowers.

In such appliances there exists the problem that, when cutter or blade structures of the appliances are started up, high working forces develop at the same cutter or blade structures, meaning that a considerable danger potential is inherent in these appliances and therefore that the potential for injury is particularly great, especially in the case of improper or careless use of these appliances.

It is known how to provide such appliances with multi-circuit switches, so that operation of these appliances is possible only if the appliance is grasped in a certain way. Nevertheless, such switches can be manipulated. Furthermore, dangerous situations can develop despite the use of such switches.

The object of the invention is to provide solutions by which advantages in terms of operating safety are achieved during operation of motor appliances, especially hand-held gardening and forestry appliances as well as power tools.

In an initially abstract description, this object is achieved according to the invention by an appliance safety system for averting dangerous operating situations in the use of motor-powered appliances. This system comprises field-preparing means for generating a capacitive spatial alternating field and detecting means for detecting a condition that can be classified as dangerous and/or shutdown by detecting changes of the field structure during penetration of an object into the zone being sensed by each field.

Preferably an evaluation circuit is provided for classification of the dangerous and/or shutdown condition. This evaluation circuit is coupled with those detecting means, and the detecting means are designed such that they can detect electric field changes in the surrounding area of a dangerous structure.

Thereby it is advantageously possible to detect the occurrence of potential injury situations sufficiently early and to prevent startup of the dangerous components of the protected appliance.

It is possible to recognize impermissible or shutdown situations by frequency-variation effects, by phase-shift effects, by changes of the resonance behavior of LC networks and/or by intensity or threshold analyses. The inventive system can be designed to be self-calibrating.

The capacitive alternating field can be generated by an electrode device that is part of the dangerous structure.

The capacitive alternating field can also be generated by an electrode device disposed in proximity to the dangerous structure.

Furthermore, the capacitive alternating field can also be generated by an electrode device disposed in a zone of access to the dangerous structure.

The alternating field can also be coupled into a voltage supply cable, especially in combination with the aforesaid measures, so that, for example, operation of the appliance is prevented by impermissible approach to the cable.

It is possible to provide a switching device to disconnect the connection of the voltage supply cable. This switching device can be provided in the end region of the connector end of the voltage supply cable. It is possible to initiate activation of the switching device via signal events coupled into the cable.

According to a particularly preferred embodiment of the invention, the capacitive alternating field can also be generated by coupling into the user. Such coupling can be achieved by a circuit device to be worn or carried by the user, such as an ID card. It is also possible to achieve coupling by an electrode device, which is disposed in a handle zone or other appliance structure close to the user during proper handling.

The capacitive alternating field can be coupled into the user in such a way that it forms an aura surrounding the user. Even in this case the capacitive alternating field can be generated by a system component on the appliance side or by a system component to be worn or carried by the user.

It is possible to generate the capacitive alternating field under the influence of a modulator in such a way that it carries an information content. This information content can be evaluated, for example, as proof of authorization.

In the present context, danger is to be understood especially but not exclusively as danger due to clamping, pinching, cutting, heat, cold and electric current.

The invention also relates to the components of the said system as such. Furthermore, the invention also includes the protective methods that can be achieved by the aforesaid apparatus-related measures for turning off the drive of dangerous structures in appliances, especially gardening or forestry appliances or other cutting tools.

Further details and features of the invention will become apparent from the description hereinafter in conjunction with the drawings.

The inventive appliance safety system is suitable in particular for authorization-verified use of cutting gardening appliances with further protective features.

Effects achievable on the basis of the inventive concept:
Only authorized persons can start the appliance
Appliance starts only if properly handled
Appliances start only if the required and especially personal protective gear is being used as designed

For protection against injury, the following protective features in particular can be implemented:
Sensor prevents cable from being severed and therefore also protects persons
Sensor protects persons from injury
   Sensor protects the operator himself
   Sensor protects unauthorized persons
   Sensor protects helpers

As further safety features, the following effects in particular are achievable:
Protection against theft
Child safety
Recorded use (running time, damage, malfunction, opening, service)

The invention relates in particular to protection from cutting gardening appliances powered by electric motors, such as hedge clippers, chippers, lawnmowers, power saws, etc. Such appliances are often readily accessible to persons (such as children) and in principle are potentially dangerous to use.

Besides unauthorized operation, the main danger points are improper handling, which can cause harm to persons and property. Additional gripping handles are therefore equipped with mechanical switches, although these can be manipulated (adhesive tape). If the power cord is severed, it can lead to electric shock. Cutting parts can intrude into the zone of body parts and injure them, for example if the appliance is not properly held and steered. Gardening appliances can also be stolen.

For certain gardening appliances (power saws, trimmers, etc.), it is strongly recommended that personal protective gear be worn, although this is not always done.

Since gardening appliances face tough sales competition, a solution to the problem must not be expensive or complicated.

The present invention advantageously solves the known problem, partly by contactless means. For this purpose, a capacitive alternating field such as an aura is generated around an authorized operator, his helpers and/or the power cord. Detection of this aura by a suitable detector allows the appliance to be turned on if it is handled properly. On the other hand, abusive operation leads to immediate shutdown, well before the cutting device can reach a human body part or the electrical supply line.

The presentation of an alternating field that permits activation can also be achieved by personal protective gear, which can also be composed of multiple parts.

On the basis of the inventive concept, it is possible to design hedge clippers that turn off automatically as soon as the cutting zone gets impermissibly close to the voltage supply cable. Both the cutting system and the cable can be connected as receiving means to a sensor system comprising an LC network. Preferably the protective field is generated by the cutting system. If this protective field is coupled into the cable, shutdown will take place.

Further details and features of the invention will become apparent from the description hereinafter in conjunction with the drawing, wherein:

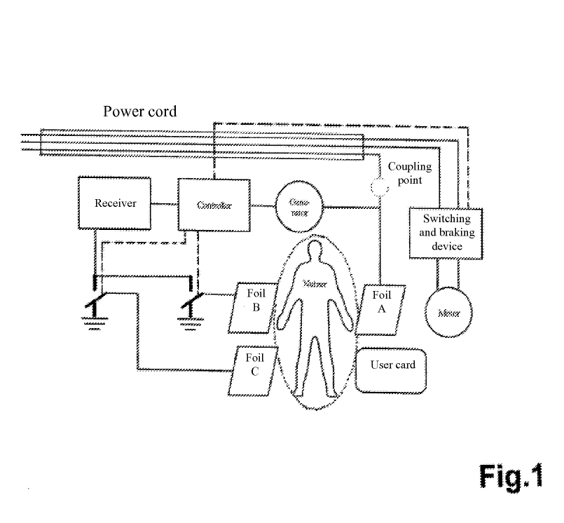

FIG. 1 shows a schematic diagram for illustration of the inventive concept for safeguarding a motor appliance;

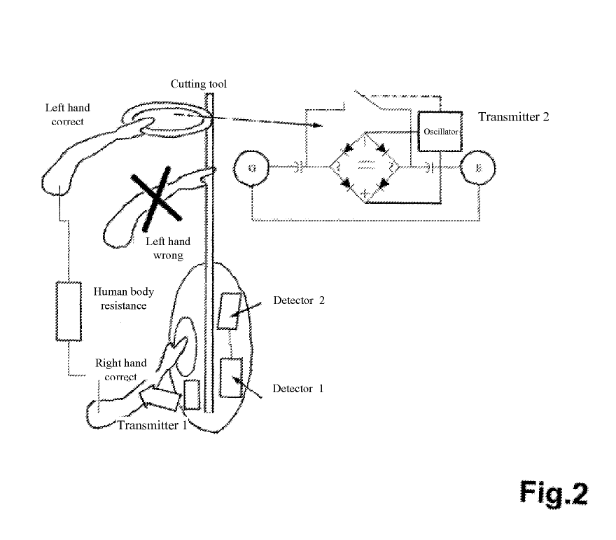

FIG. 2 shows a schematic diagram for illustration of the further operating principle of an inventive system;

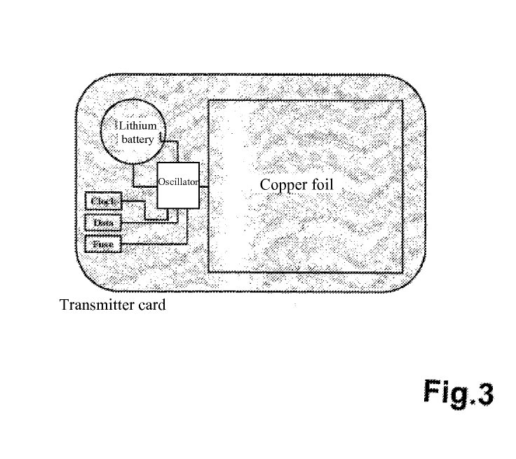

FIG. 3 shows a simplified diagram of an element that is configured as a transmitter card and that is used for coupling an inherently quasi-static alternating field into a user;

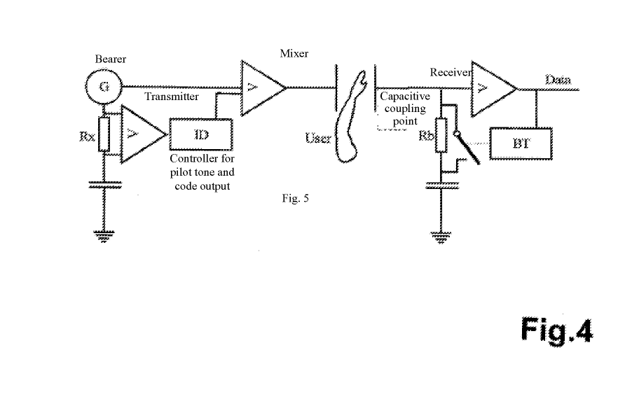

FIG. 4 shows a schematic diagram for illustration of the signal transmission between a transmitter and a receiver by including the limbs of a user;

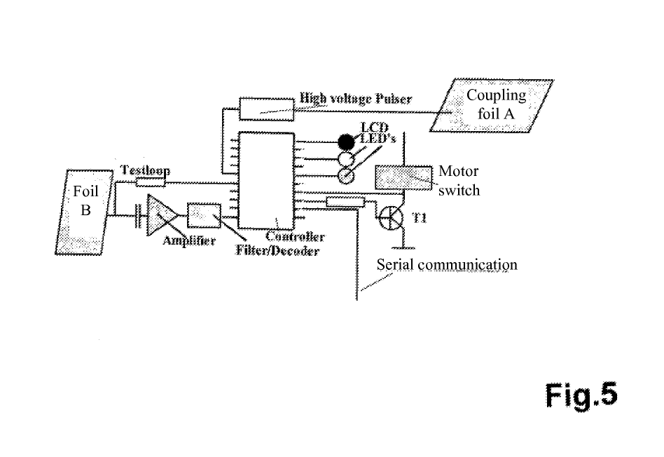

FIG. 5 shows a schematic diagram of a receiving and evaluation system capable of indicating the different proximity conditions;

FIG. 1 schematically shows the structure of a gardening appliance, which comprises a switching and braking device as well as an electric motor. The invention provides a generator, which can capacitively output a medium-frequency alternating voltage (such as 200 kHz) at foil A. This is preferably mounted in the handle in proximity to the power switch. A second foil B is located, for example, in an additional gripping handle. It is mandatory for this to be surrounded with the other hand. As an example, a user carries a user card on his person, and a helper carries a protective card.

These cards generate data-modulated alternating fields, which are transmitted capacitively to the skin of the respective bearer and create an “artificial aura”, which can be sensed, detected and demodulated by a suitable receiver at a definable distance of 0 to approximately 30 cm. If the user authorized in this way turns the appliance on, the internal controller first checks, via foil B, the authorization code of the user card transmitted via the skin. Simultaneously, it is ensured that the user is actually also using the handle (in which foil B has been mounted).

Thereupon the appliance can be started. The controller then turns foil B off and foil C on. This is in communication capacitively with the cutting mechanism. Via foil A there is now to the operator's skin a modulated alternating voltage signal (pulse), which can be modulated with a shutdown code. The pulse voltage is designed such that the “artificial aura” around the user is intensified. If this now comes too close together with body parts to the cutting mechanism, this is detected by the receiver and the motor of the appliance is immediately stopped, until the operator has removed his members once again from the danger zone of the cutting mechanism. In this way a serious injury can be prevented. Since the shutdown signal of foil A also acts on the power cord, this is protected in the same way from being severed, and the operator is protected from electric shock that could then ensue.

Helpers can be equipped with a device (for example, in the form of a credit card), which generates a shutdown alternating voltage signal and couples it capacitively into the skin of its bearer, so that an “artificial protective aura” is also formed around the helper. If the helper comes too close to the cutting mechanism, the receiver can detect this and stop the motor before injuries occur.

According to FIG. 2, the invention presents a further circuit, by which it can be ensured that certain zones of a cutting tool are not touched.

Handles are often mounted on metal bars; the housing containing the drive motor is attached to their lower end, and the cutting mechanism is attached to the upper end. Since the handle is often adjustable, it should not be cabled. For this reason there is mounted in the handle a rectifier, which rectifies the alternating field of transmitter 1 only if the handle is touched, thus driving an oscillator, which operates at a different frequency, which detector 2 can receive. In contrast, if the bar is touched, the signal for detector 2 disappears, leading to shutdown of the appliance.

Structure of a Transmitter Device

A transmitter is composed of an oscillator, which preferably generates a square-wave signal (approximately 200 kHz). If necessary, the voltage of this signal can be boosted via a series resonance circuit. Thereafter it is passed to a conductive surface (such as copper foil). This forms one side of a capacitor. The other side is formed by the human skin.

In this way, data can also be transmitted by turning the oscillator on and off and/or by changing the frequency according to a particular pattern. Such transmitters can be mounted in the gardening appliances or, as illustrated in FIG. 3, can be carried by the operator in the form of a credit card. On the outside, the foils are insulated, for example with plastic or lacquer.

In principle, the turn-on and shutdown signals are different. Whereas operators carry turn-on transmitters, helpers should carry shutdown transmitters. In this way it is ensured that helpers cannot operate the appliances, but they can shut them down if a helper strays into the danger zone of the cutting mechanism. The operator himself is protected via the shutdown signal present in the gardening appliance (foil A), which also protects the power cord from being severed. The appliance can be turned on only if the operator is carrying a turn-on transmitter AND grasping the appliance as required by the regulations. Since the appliance will not start without (coded) activation signal, this effect can also be used, for example, for theft protection and/or child safety.

FIG. 4 shows the structure of a transmitter and receiver for the “artificial aura” of capacitive alternating fields.

A receiving foil (for example of copper) with dielectric (plastic of the appliance housing or of the handle) is connected to a selective amplifier, a filter and a decoding device. An alternating current circuit (extremely weak) is closed via the human skin (for example, between foil A and foil B, as a so-called body bridge). Portable transmitters (cards) form this circuit parasitically to ground. As the input amplifier there can be used high-impedance operational amplifiers (such as Max9003), transimpedance amplifiers (such as TEMIC U2538B with integrated decoder) or comparators with a parallel resonance circuit on the input side.

FIG. 6 shows further possible configurations of the inventive system:
Sequential switching: first a grasping handle must be surrounded, after which the machine can be turned on at the main handle
Releasing the grasping handle stops the machine, but regripping it has no effect. To ensure that the machine does not start accidentally, it must be turned on again at the switch (a RED-colored LED signals: FULL STOP)
Upon approaching the power cord or a body part of the operator/helper, the motor stops, but it resumes running when the danger no longer exists (yellow-colored LED: DANGER)
A green LED can indicate proper handling
The system can also record operating data (running times, malfunctions, change of operator, danger incidents, etc.) and output them via the capacitive coupling point. An external receiver can be connected via an interface to a PC
A spiral arrangement of the internal coupling surfaces can be used in order to detect when the hand surrounds a handle. A second signal couples into the surface when it is not shielded by a surrounding hand (Faraday cage).

1. An appliance safety system for averting a dangerous operating in the use of motor-powered appliances, the system comprising:
a field-preparing means for generating a capacitive alternating field and detecting means for detecting one of a dangerous and shutdown condition,
an evaluation circuit for classification of the one of dangerous and shutdown condition, the evaluation circuit being coupled with the detecting means, and
wherein the detecting means is designed such that it can detect electric field changes in a surrounding area of a dangerous structure.

2. An appliance safety system according to claim 1, characterized in that the capacitive alternating field is generated by an electrode device that forms part of the dangerous structure.

3. An appliance safety system according to claim 1, characterized in that the capacitive alternating field is generated by an electrode device disposed in proximity to the dangerous structure.

4. An appliance safety system according to claim 1, characterized in that the capacitive alternating field is generated by an electrode device disposed in a zone of the dangerous structure that can be one of accessed and grasped.

5. An appliance safety system according to claim 1, characterized in that the alternating field is coupled into a voltage supply cable.

6. An appliance safety system according to claim 5, characterized in that there is provided a switching device to disconnect the connection of the voltage supply cable.

7. An appliance safety system according to claim 5, characterized in that the capacitive alternating field is generated by coupling into a user.

8. An appliance safety system according to claim 5, characterized in that the capacitive alternating field is generated as an aura surrounding the user.

9. An appliance safety system according to claim 8, characterized in that the capacitive alternating field is generated by a system component on the appliance side.

10. An appliance safety system according to claim 9, characterized in that the capacitive alternating field is generated by a system component to be worn or carried by the user.

11. An appliance safety system according to claim 10, characterized in that the capacitive alternating field is generated under the influence of a modulator, in such a way that it carries an information content.

12. An appliance safety system according to claim 11, characterized in that the information content can be evaluated as proof of authorization.

13. An appliance safety system according to claim 12, characterized in that the system is implemented in conjunction with a gardening appliance.

14. An appliance safety system according to claim 13, characterized in that the system component to be worn or carried by the user is designed as a utility card element.

15. An appliance safety system according to claim 14, characterized in that the system component to be worn or carried by the user is integrated into a protective device to be worn or carried by the user.

16. A gardening appliance with an appliance safety system for averting dangerous operating situations in the use of same, with a field-preparing means for generating a capacitive alternating field and detecting means for detecting a condition that can be classified as dangerous and/or shutdown, wherein there is provided an evaluation circuit for classification of the dangerous and/or shutdown condition, and this evaluation circuit is coupled with those detecting means, and the detecting means are designed such that they can detect electric field changes in the surrounding area of a dangerous structure.

17. An operational circuit component as a component of a safety system for permitting the operation of a gardening appliance that is equipped with an appliance safety device complementary to the operational circuit component, for averting dangerous operating situations in use of the gardening appliance, comprising:
a field-preparing means for generating an electric field aura that surrounds a user.

18. An operational circuit component according to claim 17, characterized in that there are provided detecting means on the appliance side for detecting a condition that can be classified as dangerous or shutdown, wherein there is provided an evaluation circuit for classification of the dangerous or shutdown condition, and this evaluation circuit is coupled with those detecting means, and the detecting means are designed such that they can detect electric field changes in the surrounding area of a dangerous structure.
